(19) United States
(12) Patent Application Publication
(10) Pub. No.: US 2008/0284371 A1
(43) Pub. Date: Nov. 20, 2008

(54) Multi-functional power storage and supply device

(76) Inventor: Yu-Che Hsu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/149,873

(22) Filed: May 9, 2008

(30) Foreign Application Priority Data
May 18, 2007 (TW) 96117836

(51) Int. Cl. H02J 7/02; H02J 7/00

(52) U.S. Cl. 320/111; 320/113

(57) ABSTRACT

Disclosed herewith a multi-functional power storage and supply device for providing power to a variety of portable electronic devices includes a housing having a battery mounting surface. A battery pack is electrically and detachably attached to the battery mounting surface of the housing. At least one rechargeable battery is disposed within the battery pack, and is provided with a pair of outputs. A power charging circuit connectable to an external power source is arranged to charge the rechargeable battery with a charging voltage via a charging circuit once the device is connected to a power source. And at least one USB port is connected to the power charging circuit, and which is in turn connected to the outputs of the battery via a boosting circuit for charging an electronic device coupled thereon with the external power source or the power stored in the battery.

### FIELD OF THE INVENTION

The present invention relates to a power storage and supply device, and more particularly to a multi-functional power storage and supply device which can be used to recharge a portable electronic device through external power source, such as both wall-mount outlet as well as vehicle socket outlet, and a battery pack built-in thereof thereby can readily provide instant power supply to a variety of electronic devices.

### BACKGROUND OF THE INVENTION

In our modernized and commercial society, portable electronic devices, which are featured with compact design and readily convenient to meet people requirements, have inevitably and unnoticeably become a trend and phased out those old-fashioned electronic devices. Among those electronic devices, portable multi-media electronics bring about a great deal of convenience to our daily life as the user can use it to entertain themselves anytime, anywhere thorough all kinds of audio and video media and featured effects stored therein. Pressure built-up from work can be comfortably relieved and released. Furthermore, performance of work and quality of life are also promoted. Typical portable electronic devices include mobile phone, personal digital assistant (PDA), portable computer, stock receiving unit, etc.

Nevertheless, for the user, the most bothersome and inconvenient issue is the power supply. Almost every user shares the same common experience. Currently, the market available electronic devices are all powered with a built-in and/or external battery pack. For example, the mobile phone is generally powered by lion and/or nickel cadmium battery. For save and backup, users always keep one or two additional battery packs for backup in addition to the built-in battery. In actual use, the back-up battery pack creates a problem as the user needs to find a place to keep it and carry it. On the other hand, each electronic device generally is designed to function only under certain voltage specification. As a result, in case the built-in power of the electronic is exhausted, the battery pack from the other electronic device can not necessarily be used for its back-up power source. Accordingly, it becomes a must to prepare each and every electronic device a backup battery pack tailored and specified to it. Not only will it create a problem when using them, but will also increase the operation cost for the electronic devices. Specially, if the backup battery pack is stored for an extensive period of time, the activity of the battery pack will deteriorate and even the battery pack becomes un-useable. Furthermore, even these electronic device is provided with a charging device, it can only be connected to a wall-mount outlet.

### SUMMARY OF THE INVENTION

It is an object of the present invention to provide a multi-functional power storage and supply device which can readily provide power to a variety of portable electronic devices.

In order to achieve the object set for, a multi-functional power storage and supply device made in accordance with the present invention comprises a housing having a battery mounting surface. A battery pack is electrically and detachably attached to the battery mounting surface of the housing. At least one rechargeable battery is disposed within the battery pack, and is provided with a pair of outputs. A power charging circuit connectable to an external power source is arranged to charge the rechargeable battery with a charging voltage via a charging circuit once the device is connected to a power source. And at least one USB port is connected to the power charging circuit connected to the output of the battery via a boosting circuit for charging an electronic device coupled thereon with the external power source or the power stored in the battery.

According to one aspect of the present invention, the USB port is arranged in a predetermined position of the housing.

Yet still according to another aspect of the present invention, the USB port can be arranged in a predetermined position of the battery pack.

By the provision of the present invention, the device made according to the present invention can be recharged through a variety of power source, conveniently supplying the user anytime anywhere as long as the portable electronic devices need to replenish.

### BRIEF DESCRIPTION OF THE DRAWINGS

FIG. 1 is a exploded perspective view of a power storage and supply device constructed in accordance with the present invention;

FIG. 2 is a bottom view of the device of FIG. 1;

FIG. 3 is a perspective view of the device of FIG. 1;

FIG. 4 is a side view of the device of FIG. 1;

FIG. 5 is an illustration showing a portable electronic device is connected to the device of the present invention;

FIG. 6 is a top view of the device of FIG. 1; and

FIG. 7 is a block diagram of a controlling circuit incorporated with the device in FIG. 1.

### DETAILED DESCRIPTION OF THE PREFERRED EMBODIMENTS

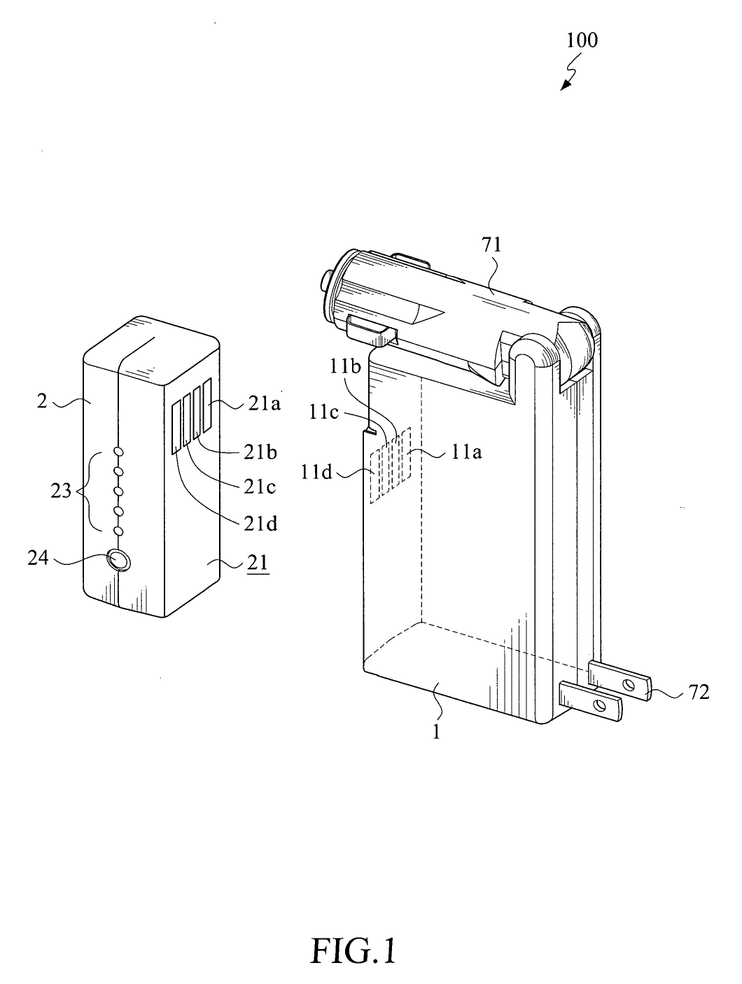

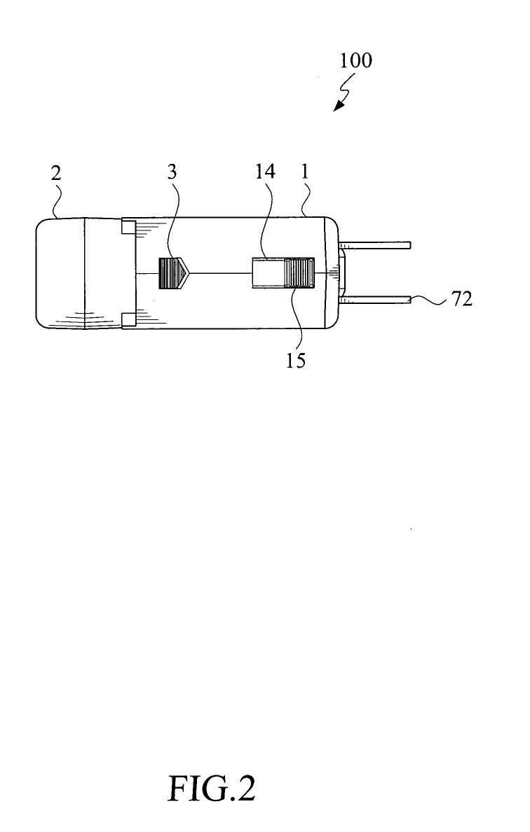

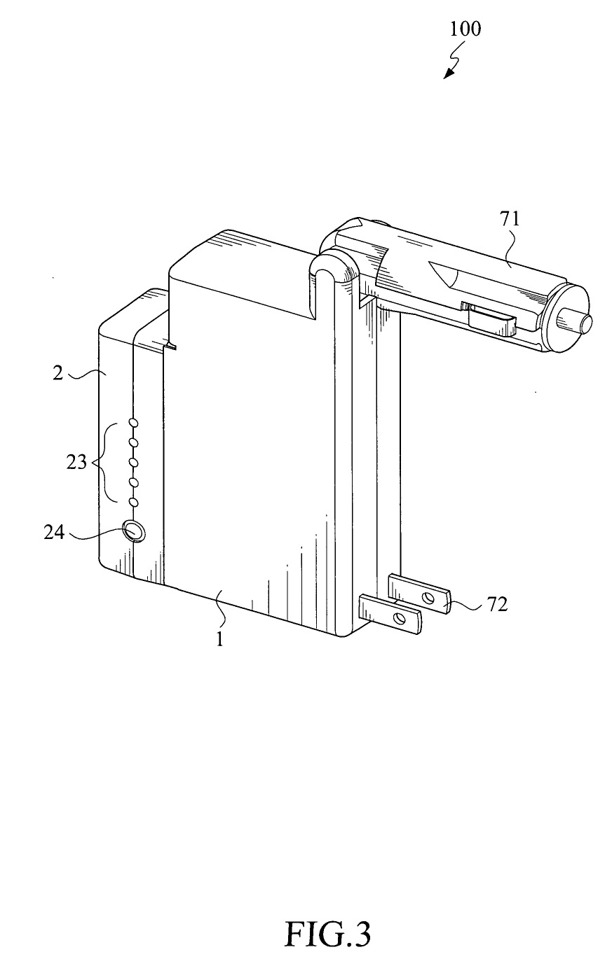

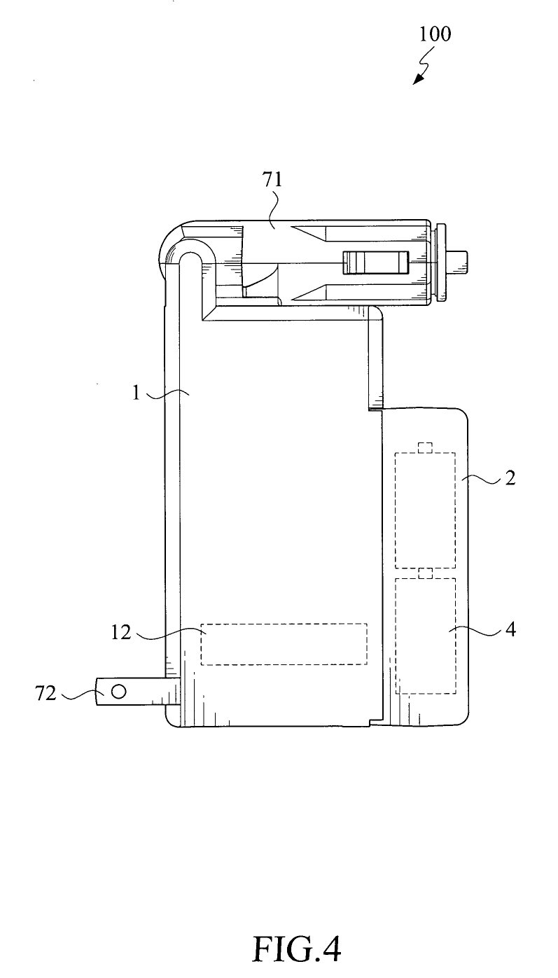

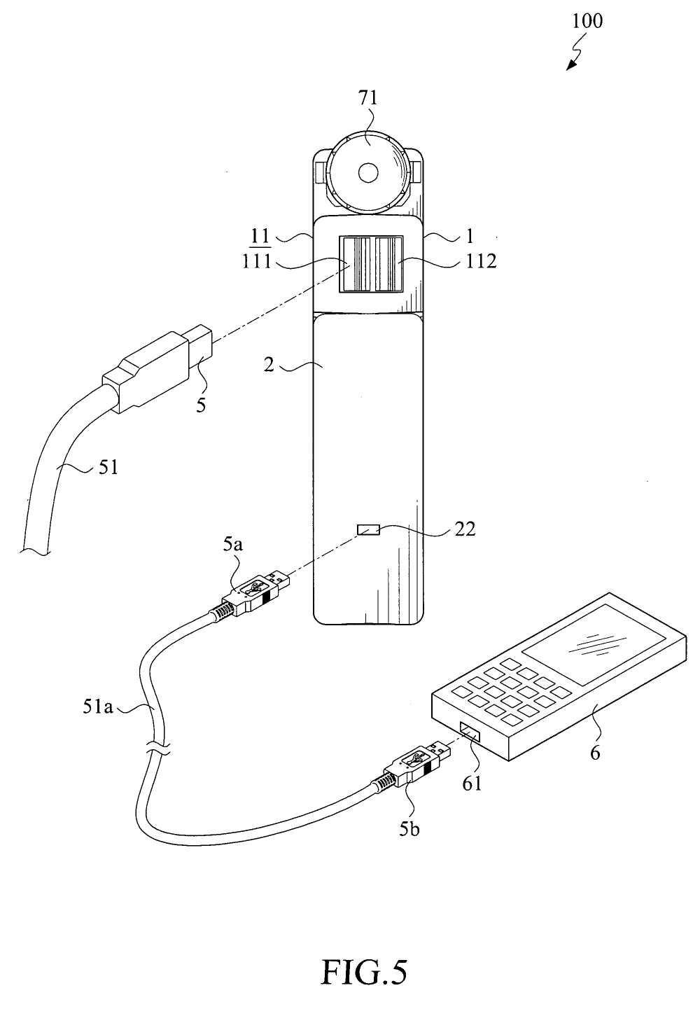

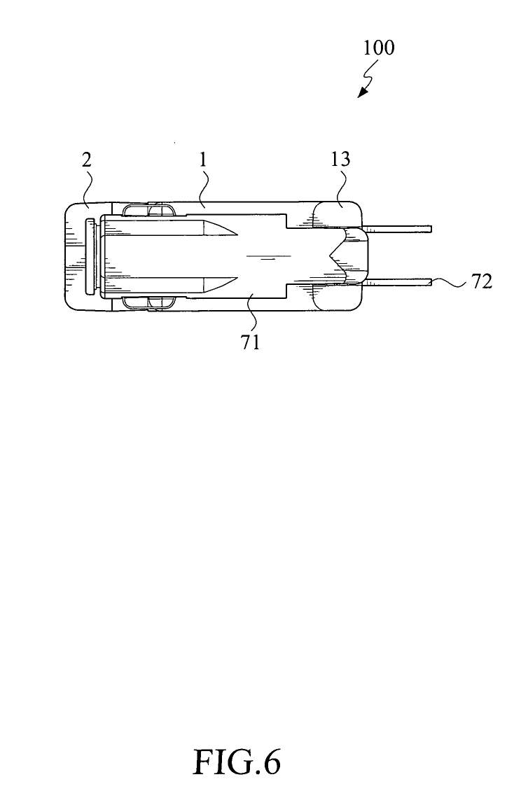

Referring now to FIGS. 1 to 6, a multi-functional power storage and supply device constructed in accordance with the present invention is illustrated in FIG. 1, as its exploded perspective view; FIG. 2, as its bottom view; FIG. 3, as its perspective view; FIG. 4, as its side view; FIG. 5, as an illustration showing a portable electronic device is connected thereto; and FIG. 6, showing a top view thereof, respectively. The multi-functional power storage and supply device 100 constructed in accordance with the present invention generally includes a housing 1, a latch mechanism 3, at least a rechargeable battery 4, a vehicle plug 71 for coupling with a vehicle socket outlet, and a second plug 72 for wall-mount outlet.

The housing 1 is provided with a battery mounting surface 11 on which four electrical contacts 11a, 11b, 11c, and 11d are arranged in a pre-determined position. The battery pack 2 is provided with a latching side 21 corresponding to the battery mounting surface 11 of the housing 1, and further provided with four conductive pads 21a, 21b, 21c, and 21d with respect to the four electrical contacts 11a, 11b, 11c, and 11d of the housing 1 so as to establish an electrical connection with the housing 1 once the battery pack 2 is securely attached to the battery mounting surface 11 of the housing 1 by means of the latching mechanism 3 of the battery pack 2.

The housing 1 is further provided with a stacked USB ports or receptacle 111, 112 at a position right above the four conductive contacts 11a, 11b, 11c, and 11d. The USB ports 111, 112 can receive a USB plug 5, see FIG. 5 for illustration. The USB plug 5 is terminated with a cable 51 which is connected to a portable electronic device 6 to be recharged.

At least one rechargeable battery 4 is disposed within the battery pack 2 which is further provided with a mini USB port 22 on the face opposite to the latching side 21. A mini USB plug 5a can be received into the mini USB port 22, and another mini USB plug 5b, which is connected with the mini USB plug 5a via a cable 51a, can plug into a mini USB port/receptacle 61 of the portable electronic device 6. By this arrangement, the power storage and supply device 100 constructed in accordance with the present invention can be used to charge different portable electronic devices as long as USB interface is arranged thereon.

A print circuit board 12 is disposed within the housing 1, and the housing 1 is further provided with a shaft 13, by means of which the vehicle plug 71 is assembled to the housing 1. By this arrangement, the vehicle plug 71 can be rotated around the shaft 13 to certain angles so as to conveniently insert into a socket outlet of a vehicle, or even a DC outlet on an airplane to access power supply therefrom. The housing 1 is further provided with a plug 72 opposite to the battery mounting surface 11. The plug 72 can be readily inserted into a wall-mount outlet for household AC power.

The housing 1 is further provided with a slot 14 on a bottom surface at a predetermined position, and a pusher 15 is moveably arranged within the slot 14 and is coupled to the plug 72. Normally, the plug 72 is completely retrieved within the housing 1, and when in use, the pusher 15 can be pushed such that the plug 72 can be pushed out of the housing 1 and then inserted into a wall-mount outlet for receiving power supply therefrom. After the battery pack 2 completes charging, the pusher 15 is pushed back to retrieve the plug 72 into the housing 1.

The battery pack 2 is provided with an indicator 23 and a push button 24. The indicator 23 is electrically connected to the rechargeable battery 4, and the push button 24 is used to trigger the indicator 23 so as to display the remaining capacity of the rechargeable battery 4.

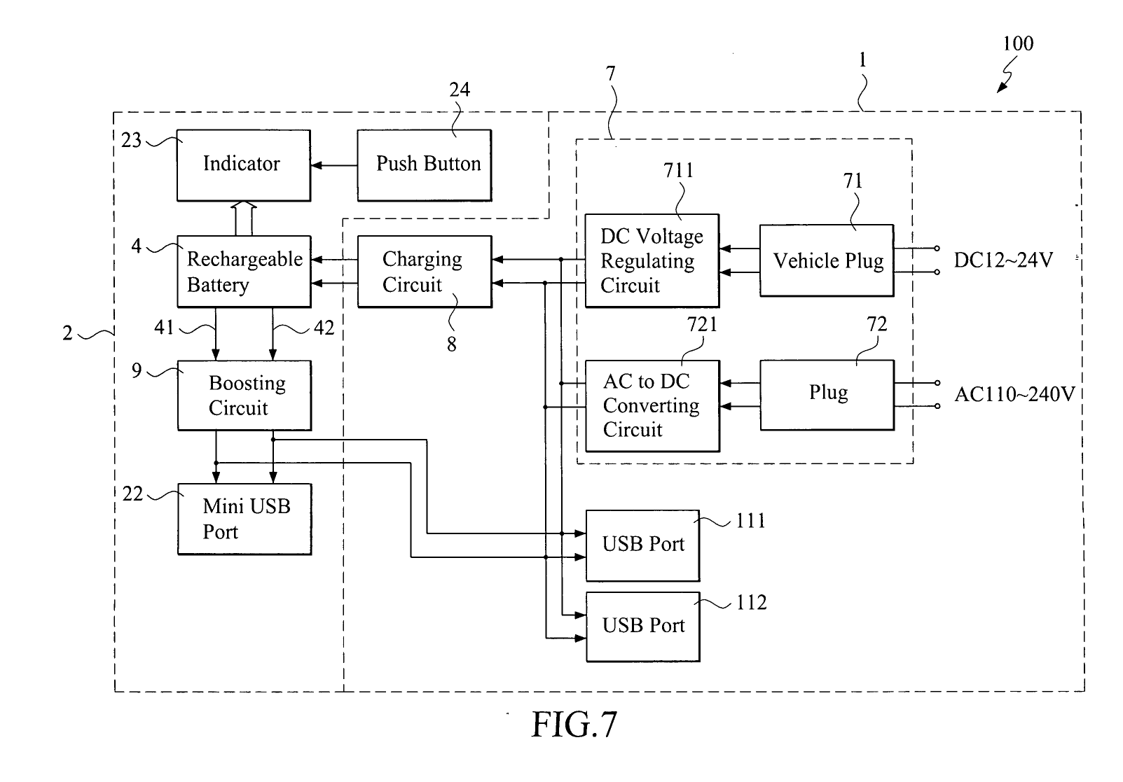

Referring to FIG. 7, a controlling circuit incorporated with the device of FIG. 1 is shown. The controlling circuit includes a power supply circuit 7, a charging circuit 8, and a boosting circuit 9. The power supply circuit 7 is used to get access to an external power source, and which comprises the vehicle plug 71 rotationally mounted on the housing 1, a DC voltage regulating circuit 711, an AC to DC converting circuit 721, and the plug 72 rotatably arranged on the housing 1. The charging circuit 8 is arranged between the rechargeable battery 4 and the power supplying circuit 7, and the charging circuit 8 is provided with a pair of outputs 41, 42.

The USB ports 111, 112 are connected, to the DC voltage regulating circuit 711 and the AC to DC converting circuit 721, and which are also connected to the output 41, 42 of the rechargeable battery 4 via the boosting circuit 9. As a result, the, electrical energy retrieved from the external power source through the power supply circuit 7 can be readily output to the portable electronic devices connected thereto. Alternatively, if the battery pack 2 is attached to the housing 1, then the power stored in the rechargeable battery 4 can also readily output through the USB ports 111, 112 to the electronic devices coupled thereto.

The mini USB 22 arranged on the battery pack 2 is connected to the output 41, 42 via the boosting circuit 9. In addition, the mini USB 22 is further connected to both the DC voltage regulating circuit 711 and the AC to DC converting circuit 721 such that the electrical energy stored in the rechargeable battery 4 or the electrical energy supplied from the external power source through the power supply circuit 7 can be supplied to the mini USB 22, when the battery pack 2 is attached to the housing 1.

The vehicle plug 71 is used to insert into the vehicle socket outlet or socket outlet of an airplane so as to get the power source. Once the vehicle plug 71 is plugged, the DC power is then regulated by the DC voltage regulating circuit 711 to a preset range such that the regulated voltage can be readily available at the USB ports 111, 112 and the mini USB port 22 arranged on the battery pack 2, if electrically attached to the housing 1. Meanwhile, the regulated voltage can also used to charge the rechargeable battery 4 through the charging circuit 8 as the battery pack 2 is electrically attached to the housing 1. The DC voltage input from the vehicle plug 71 is about 12-24 volts, and it is regulated to 5.3 volts after going through the DC voltage regulating circuit 711.

The plug 72 can be used to insert into a wall-mount outlet to receive AC power source therefrom. The AC power is then converted into a DC power through the AC to DC converting circuit 721, and then is supplied to the USB ports 111, 112 and the mini USB port 22 arranged on the battery pack 2. Meanwhile, the converted voltage can also used to charge the rechargeable battery 4 through the charging circuit 8 when the battery pack 2 is electrically attached to the housing 1. The AC voltage input from the vehicle plug 71 ranges between 110˜120 volts, and it is converted down to 5.3 volts after going through the AC to DC converting circuit 721.

The nominal output voltage of the rechargeable battery 4 is about 3.6 volts, while the output voltage at the USB ports 111, 112 and mini USB port 22 is 5.3 volts. Accordingly, the output voltage from the rechargeable battery 4 has to be boosted from 3.6 volts up to 5.3 volts thereby supplying the requested voltage to the mini USB port 22 of the battery pack 2 and the USB ports 111, 112 of the housing 1, when the battery pack 2 is electrically and mechanically attached to the housing 1.

When the battery pack 2 is detached from the housing 1, and if there is capacity remained within the rechargeable battery 4, then the battery pack 2 can be used to supply the requested power to any electronic devices directly and individually through the mini USB 22. That means that the mini USB 22 can be used to supply the portable electronics with the capacity from the rechargeable battery 2. On the other hand, the housing 1, without the battery pack 2 electrically and mechanically attached thereto, can be plugged into the vehicle socket outlet or socket outlet from the airplane to get access the DC power source as to have the output voltage readily available at the USB ports 111, 112 to support the functionally operation of the electronic devices connected thereto. Alternatively, the plug 72 can be plugged into the wall-mount outlet to get access of power source such that the USB ports 111, 112 of the housing 1 can be used to supply the portable power supply coupled thereto.

From the description and disclosure discussed above, the power storage and supply device made by the present invention has achieved its intended, objectives, and expresses its novelty, utility. Specially, it can readily resolve the problems encountered by the users of the portable electronics addressed and discussed above. While the present invention has been described in connection with the preferred embodiment, it is to be understood that other similar embodiments may be used or modifications and additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A multi-functional power storage and supply device, comprising:
a housing having a battery mounting surface;
a battery pack electrically and detachably attached to the battery mounting surface;
at least one rechargeable battery disposed within the battery pack, and having a pair of outputs;
a power charging circuit connectable to an external power source to charge the rechargeable battery with a charging voltage via a charging circuit; and
at least one USB port connected to the power charging circuit which in turn is connected to the output port of the battery via a boosting circuit for charging an electronic devices coupled thereon with the external power source or the power stored in the battery.

2. The device as recited in claim 1, wherein the USB port is arranged in a predetermined position of the housing.

3. The device as recited in claim 1, wherein the USB port is arranged in a predetermined position of the battery pack.

4. The device as recited in claim 3, wherein when the battery pack is detached from the housing, the USB port of the battery pack is used as a power output.

5. The device as recited in claim 1, wherein the power charging circuit includes a vehicle plug connectable to a socket outlet of a vehicle and a DC voltage regulating circuit, the vehicle plug being arranged at a predetermined position of the housing for receiving power from a vehicle, and the DC power resource received being further regulated by the DC voltage regulating circuit thereby providing an output voltage at the USB port of the housing, while simultaneously charging the battery pack.

6. The device as recited in claim 1, wherein the charging circuit includes an AC plug and an AC to DC converting circuit, and the AC plug being arranged in a predetermined position of the housing for readily coupling to an AC power source, and the AC power being converted into a DC by means of the AC to DC converting circuit, thereby providing an output voltage at the USB port of the housing, while simultaneously charging the battery pack.

7. The device as recited in claim 1, wherein the battery pack is provided with an indicator electrically connected to the rechargeable battery and a push button used to trigger the indicator so as to display the remaining capacity of the battery.

8. The device as recited in claim 1, wherein the battery mounting surface of the housing is provided with a plurality of conductive contacts, and the battery pack is provided with a plurality of conductive pads at a latching side corresponding to the plurality of contacts.

9. The device as recited in claim 8, further comprising a latching mechanism to securely attaching the battery pack to the battery mounting surface of the housing such that the conductive pads of the battery pack electrically contact with the conductive contacts of the housing.
